(19) United States
(12) Patent Application Publication
(10) Pub. No.: US 2018/0017079 A1
(43) Pub. Date: Jan. 18, 2018

(54) VARIABLE-CYCLE COMPRESSOR WITH A SPLITTERED ROTOR

(71) Applicant: General Electric Company, Schenectady, NY (US)

(72) Inventors: Anthony Louis DiPietro, JR., Mainesville, OH (US); Andrew Breeze-Stringfellow, Montgomery, OH (US); Gregory John Kajfasz, Morrow, OH (US)

(21) Appl. No.: 15/211,730

(22) Filed: Jul. 15, 2016

(51) Int. Cl. F04D 29/56; F04D 29/32; F04D 25/04; F02C 3/04; F04D 29/54; F04D 19/02

(52) U.S. Cl. CPC F04D 29/563; F04D 29/544; F04D 19/02; F04D 25/045; F02C 3/04; F04D 29/324; F05D 2220/32; F05D 2240/12; F05D 2240/35

(57) ABSTRACT

A variable-cycle compressor includes: an axial-flow compressor, a flowpath downstream of the compressor, and at least one variable-cycle device operable to vary a choked flow capacity of the downstream flowpath. The compressor includes: a rotor having at least one rotor stage including a rotatable disk defining a rotor flowpath surface and an array of axial-flow rotor airfoils extending outward from the flowpath surface; at least one stator stage including a wall defining a stator flowpath surface, and an array of axial-flow stator airfoils extending away from the stator flowpath surface. At least one stage includes splitter airfoils alternating with the rotor or stator airfoils of the corresponding stage. At least one of a chord dimension of the splitter airfoils and a span dimension of the splitter airfoils is less than the corresponding dimension of the airfoils of the at least one stage.

### STATEMENT REGARDING FEDERALLY SPONSORED RESEARCH AND DEVELOPMENT

The U.S. Government may have certain rights in this invention pursuant to contract no. FA8650-15-D-2501 awarded by the Department of the Air Force.

### BACKGROUND OF THE INVENTION

This invention relates generally to gas turbine engines and more particularly to the compressors of such engines.

A gas turbine engine includes, in serial flow communication, a compressor, a combustor, and turbine. The turbine is mechanically coupled to the compressor and the three components define a turbomachinery core. The core is operable in a known manner to generate a flow of hot, pressurized combustion gases to operate the engine as well as perform useful work such as providing propulsive thrust or mechanical work. One common type of compressor is an axial-flow compressor with multiple rotor stages each including a disk with a row of axial-flow airfoils, referred to as compressor blades.

It is desirable in some applications to provide a variable-cycle engine, in particular an engine in which the choked flow capability downstream of the compressor can be changed so as to lower the operating line of the compressor.

One problem with a variable-cycle engine is that the compressor is particularly susceptible to aerodynamic choking in the rear stages when the compressor is operating on a lower operating line. During compressor low operating line operating conditions the rear stages of the compressor move towards aerodynamic choke resulting in significantly low overall compressor performance and adiabatic efficiency levels. Therefore, any aerodynamic design or feature that can improve compressor efficiency during low operating line operation will be beneficial. One aerodynamic design approach to increase compressor efficiency during low op-line choked operation is to reduce solidity levels in the rear stage rotors providing aerodynamic choking relief. However, reduced solidity can cause undesirable hub airflow separation.

### BRIEF DESCRIPTION OF THE INVENTION

This problem is addressed by a variable-cycle compressor which incorporates splitter airfoils.

According to one aspect of the invention, a variable-cycle compressor includes: an axial-flow compressor, a downstream flowpath, and at least one variable-cycle device operable to vary a choked flow capacity of the downstream flowpath. The compressor includes: a rotor having at least one rotor stage including a rotatable disk defining a rotor flowpath surface and an array of axial-flow rotor airfoils extending outward from the flowpath surface; at least one stator stage having a wall defining a stator flowpath surface, and an array of axial-flow stator airfoils extending away from the stator flowpath surface. At least one of the rotor or stator stages includes an array of airfoil-shaped splitter airfoils extending from at least one of the flowpath surfaces thereof, the splitter airfoils alternating with the rotor or stator airfoils of the corresponding stage, wherein at least one of a chord dimension of the splitter airfoils and a span dimension of the splitter airfoils is less than the corresponding dimension of the airfoils of the at least one stage.

According to another aspect of the invention, a method of operating a variable-cycle compressor includes: using axial-flow compressor incorporating at least one row of splitter airfoils to generate a fluid flow; and during compressor operation, using at least one variable-cycle device to vary a choked flow capacity of a flowpath downstream of the compressor, thereby moving an operating line of the compressor by at least 5% from a nominal position.

### BRIEF DESCRIPTION OF THE DRAWINGS

The invention may be best understood by reference to the following description taken in conjunction with the accompanying drawing figures in which:

FIG. 1 is a schematic, half-sectional view of a gas turbine engine that incorporates a compressor rotor apparatus as described herein;

FIG. 2 is a schematic compressor map;

FIG. 3 is a perspective view of a portion of a rotor of a compressor apparatus;

FIG. 4 is a top plan view of a portion of a rotor of a compressor apparatus;

FIG. 5 is an aft elevation view of a portion of a rotor of a compressor apparatus;

FIG. 6 is a side view taken along lines 6-6 of FIG. 4;

FIG. 7 is a side view taken along lines 7-7 of FIG. 4;

FIG. 8 is a perspective view of a portion of a rotor of an alternative compressor apparatus;

FIG. 9 is a perspective view of a portion of a stator of a compressor apparatus;

FIG. 10 is a side view of a stator vane shown in FIG. 8; and

FIG. 11 is a side view of a splitter vane shown in FIG. 8.

### DETAILED DESCRIPTION OF THE INVENTION

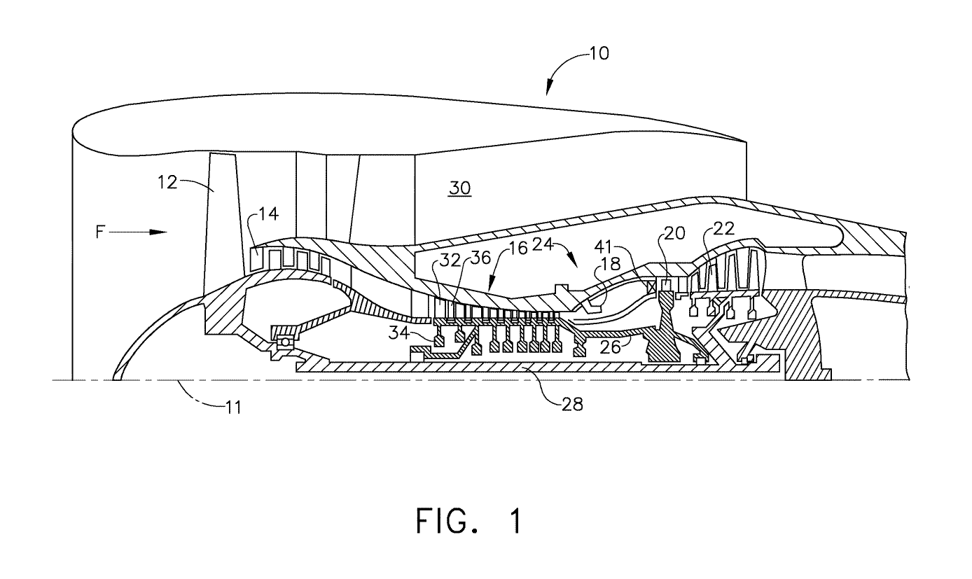

Referring to the drawings wherein identical reference numerals denote the same elements throughout the various views, FIG. 1 illustrates a gas turbine engine, generally designated 10. The engine 10 has a longitudinal centerline axis 11 and includes, in axial flow sequence, a fan 12, a low-pressure compressor or “booster” 14, a high-pressure compressor (“HPC”) 16, a combustor 18, a high-pressure turbine (“HPT”) 20, and a low-pressure turbine (“LPT”) 22. Collectively, the HPC 16, combustor 18, and HPT 20 define a core 24 of the engine 10. The HPT 20 and the HPC 16 are interconnected by an outer shaft 26. Collectively, the fan 12, booster 14, and LPT 22 define a low-pressure system of the engine 10. The fan 12, booster 14, and LPT 22 are interconnected by an inner shaft 28.

In operation, pressurized air from the HPC 16 is mixed with fuel in the combustor 18 and burned, generating combustion gases. Some work is extracted from these gases by the HPT 20 which drives the compressor 16 via the outer shaft 26. The remainder of the combustion gases are discharged from the core 24 into the LPT 22. The LPT 22 extracts work from the combustion gases and drives the fan 12 and booster 14 through the inner shaft 28. The fan 12 operates to generate a pressurized fan flow of air. A first portion of the fan flow (“core flow”) enters the booster 14 and core 24, and a second portion of the fan flow (“bypass flow”) is discharged through a bypass duct 30 surrounding the core 24. While the illustrated example is a high-bypass turbofan engine, the principles of the present invention are equally applicable to other types of engines such as low-bypass turbofans, turbojets, and turboshafts, as well as to other types of axial-flow compressors.

It is noted that, as used herein, the terms “axial” and “longitudinal” both refer to a direction parallel to the centerline axis 11, while “radial” refers to a direction perpendicular to the axial direction, and “tangential” or “circumferential” refers to a direction mutually perpendicular to the axial and tangential directions. As used herein, the terms “forward” or “front” refer to a location relatively upstream in an air flow passing through or around a component, and the terms “aft” or “rear” refer to a location relatively downstream in an air flow passing through or around a component. The direction of this flow is shown by the arrow “F” in FIG. 1. These directional terms are used merely for convenience in description and do not require a particular orientation of the structures described thereby.

The HPC 16 is configured for axial fluid flow, that is, fluid flow generally parallel to the centerline axis 11. This is in contrast to a centrifugal compressor or mixed-flow compressor. The HPC 16 includes a number of stages, each of which includes a rotor comprising a row of airfoils or blades 32 (shown schematically) mounted to a rotating disk 34, and row of stationary airfoils or vanes 36 (shown schematically). The vanes 36 serve to turn the airflow exiting an upstream row of blades 32 before it enters the downstream row of blades 32.

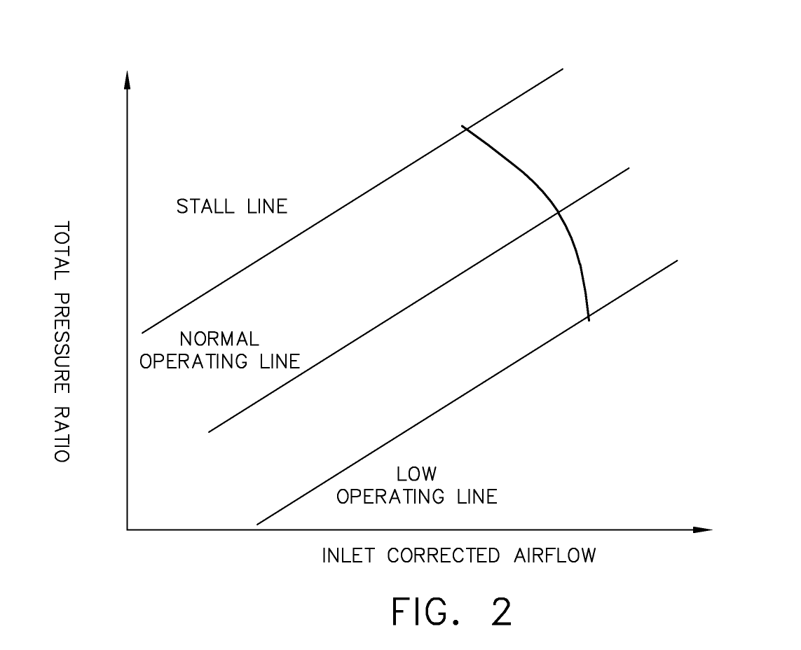

FIG. 2 is a simplified compressor map which illustrates the operating characteristics of the HPC 16. The compressor map shows total pressure ratio plotted against inlet airflow (corrected to sea level standard day conditions). A stall line is determined empirically, for example by rig testing, and represents the limit of stable operation of the HPC 16. The operating characteristics of the HPC 16 are governed by the choked flow capacity of the flowpath downstream of the HPC 16.

A normal or nominal operating line represents a locus of operating points on the compressor map during normal operation of the engine 10, with no variable-cycle aspects. The operating point of the HPC 16 along the nominal operating line is determined by fuel flowrate, which is a controllable parameter.

To accommodate various operating requirements, it is possible to change the operating characteristics of the HPC 16 and therefore move the operating line from the nominal position on the compressor map. For example in FIG. 2, a second operating line (“low operating line”) is shown positioned lower than the nominal operating line.

To accomplish his purpose the engine 10 may incorporate at least one variable-cycle device. As used herein, the term “variable-cycle” refers to any device or combination of components operable to change the choked flow capacity downstream of the HPC 16.

For example, any device which is operable to change the exit flow area downstream of the last stage of the HPC 16 would have the effect of moving the nominal operating line of the compressor map and would therefore be considered a “variable-cycle device”. In the example shown in FIG. 2, the HPC 16 would operate along the second operating line when the variable-cycle device is active.

It will be understood that some deviation from the nominal operating line is to be expected in some circumstances even without deliberate action. However, as used herein, the term “variable-cycle” implies movement of the operating line from the nominal position deliberately and by a significant amount. For example, using the variable-cycle device, the operating line may be moved or offset (e.g. lowered) from its nominal location by about 5% or more.

Nonlimiting examples of variable-cycle devices include: a variable area turbine nozzle, a variable high pressure compressor bypass system, a variable high pressure compressor bleed system, a fan having a variable pressure ratio, a variable turbine bypass system, a combustor having variable pressure drop, a combustor having a variable temperature rise, or a high pressure spool having variable mechanical power extraction. Multiple engine architectures and configurations can be utilized to achieve variable-cycle capability. In the example shown in FIG. 1, the engine 10 incorporates a variable turbine nozzle 41 (shown schematically).

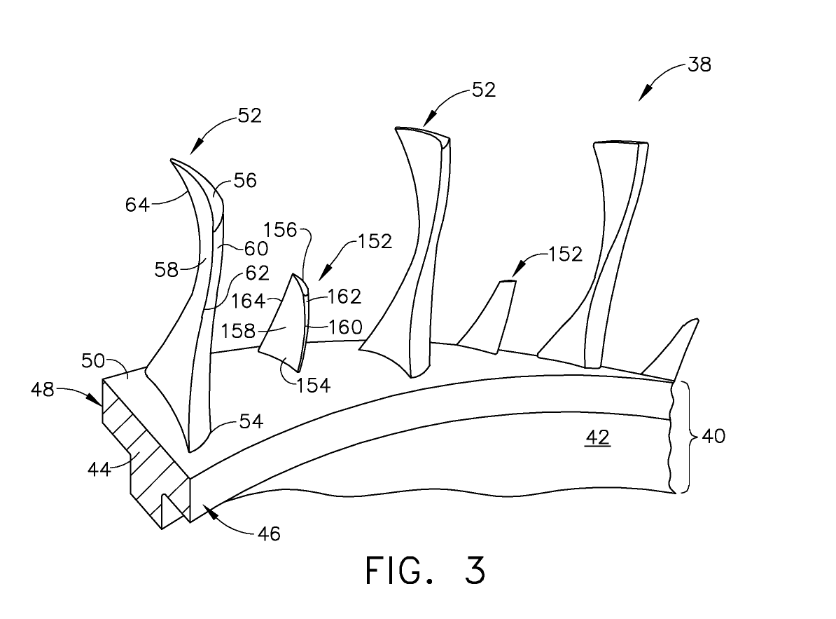

FIGS. 3-7 illustrate a portion of an exemplary rotor 38 that is suitable for inclusion in the HPC 16. As an example, the rotor 38 may be incorporated into one or more of the stages in the aft half of the HPC 16, particularly the last or aft-most stages.

The rotor 38 includes a disk 40 with a web 42 and a rim 44. It will be understood that the complete disk 40 is an annular structure mounted for rotation about the centerline axis 11. The rim 44 has a forward end 46 and an aft end 48. An annular flowpath surface 50 extends between the forward and aft ends 46, 48.

As seen in FIG. 5, the flowpath surface 50 is depicted as a body of revolution (i.e. axisymmetric). Optionally, the flowpath surface 50 may have a non-axisymmetric surface profile (not shown).

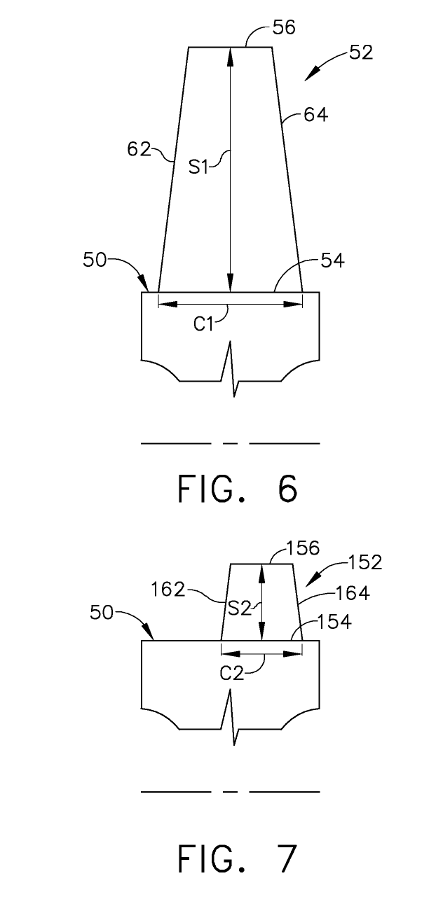

An array of compressor blades 52 extend from the flowpath surface 50. Each compressor blade 52 extends from a root 54 at the flowpath surface 50 to a tip 56, and includes a concave pressure side 58 joined to a convex suction side 60 at a leading edge 62 and a trailing edge 64. As best seen in FIG. 6, each compressor blade 52 has a span (or span dimension) “S1” defined as the radial distance from the root 54 to the tip 56, and a chord (or chord dimension) “C1” defined as the length of an imaginary straight line connecting the leading edge 62 and the trailing edge 64. Depending on the specific design of the compressor blade 52, its chord C1 may be different at different locations along the span S1. For purposes of the present invention, the relevant measurement is the chord C1 at the root 54.

The compressor blades 52 are uniformly spaced apart around the periphery of the flowpath surface 50. A mean circumferential spacing “s” (see FIG. 5) between adjacent compressor blades 52 is defined as s=2πr/Z, where “r” is a designated radius of the compressor blades 52 (for example at the root 54) and “Z” is the number of compressor blades 52. A nondimensional parameter called “solidity” is defined as c/s, where “c” is equal to the blade chord as described above. In the illustrated example, the compressor blades 52 may have a spacing which is significantly greater than a spacing that would be expected in the prior art, resulting in a blade solidity significantly less than would be expected in the prior art. Reduced solidity levels in the rear stage rotors provide aerodynamic choking relief leading to increased compressor efficiency during low op-line choked operation.

An aerodynamically adverse side effect of reduced blade solidity is to increase the rotor passage flow area between adjacent compressor blades 52. This increase in rotor passage through flow area increases the aerodynamic loading level and in turn tends to cause undesirable flow separation on the suction side 60 of the compressor blade 52, at the inboard portion near the root 54, also referred to as “hub flow separation”. To reduce or prevent hub flow separation, the rotor 38 may be provided with splitters, or “splittered”. In the illustrated example, an array of splitter blades 152 extend from the flowpath surface 50. One splitter blade 152 is disposed between each pair of compressor blades 52. In the circumferential direction, the splitter blades 152 may be located halfway or circumferentially biased between two adjacent compressor blades 52. Stated another way, the compressor blades 52 and splitter blades 152 alternate around the periphery of the flowpath surface 50. Each splitter blade 152 extends from a root 154 at the flowpath surface 50 to a tip 156, and includes a concave pressure side 158 joined to a convex suction side 160 at a leading edge 162 and a trailing edge 164. As best seen in FIG. 7, each splitter blade 152 has a span (or span dimension) “S2” defined as the radial distance from the root 154 to the tip 156, and a chord (or chord dimension) “C2” defined as the length of an imaginary straight line connecting the leading edge 162 and the trailing edge 164. Depending on the specific design of the splitter blade 152, its chord C2 may be different at different locations along the span S2. For purposes of the present invention, the relevant measurement is the chord C2 at the root 154.

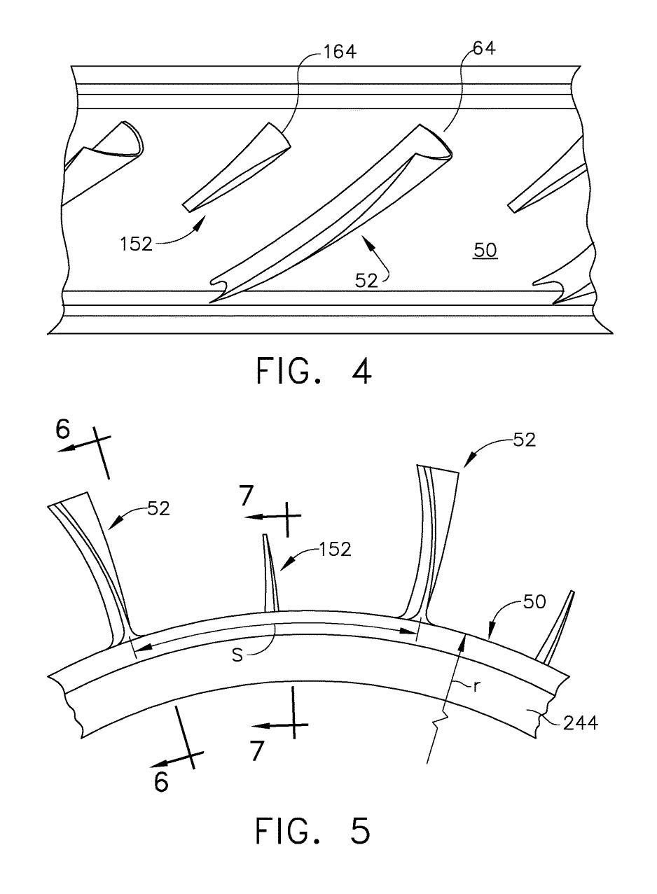

The splitter blades 152 enable reduced solidity through a majority of the rotor passage and function to locally increase the hub solidity of the rotor 38 and thereby prevent the above-mentioned flow separation from the compressor blades 52. A similar effect could be obtained by simply increasing the number of compressor blades 52, and therefore reducing the blade-to-blade spacing. An undesirable side effect of increased solidity is reduced choking relief during low op-line operation and higher inefficiency. Therefore, the dimensions of the splitter blades 152 and their position may be selected to prevent flow separation while minimizing their surface area. The splitter blades 152 are positioned so that their trailing edges 164 are at approximately the same axial position as the trailing edges 64 of the compressor blades 52, relative to the rim 44. this can be seen in FIG. 4. The span S2 and/or the chord C2 of the splitter blades 152 may be some fraction less than unity of the corresponding span S1 and chord C1 of the compressor blades 52. These may be referred to as “part-span” and/or “part-chord” splitter blades. For example, the span S2 may be equal to or less than the span S1. Preferably for reducing frictional losses, the span S2 is 50% or less of the span S1. More preferably for the least frictional losses, the span S2 is 30% or less of the span S1. As another example, the chord C2 may be equal to or less than the chord C1. Preferably for the least frictional losses, the chord C2 is 80% or less of the chord C1.

The disk 40, compressor blades 52, and splitter blades 152 may be constructed from any material capable of withstanding the anticipated stresses and environmental conditions in operation. Non-limiting examples of known suitable alloys include iron, nickel, and titanium alloys. In FIGS. 3-7 the disk 40, compressor blades 52, and splitter blades 152 are depicted as an integral, unitary, or monolithic whole. This type of structure may be referred to as a “bladed disk” or “blisk”. The principles of the present invention are equally applicable to a rotor built up from separate components (not shown).

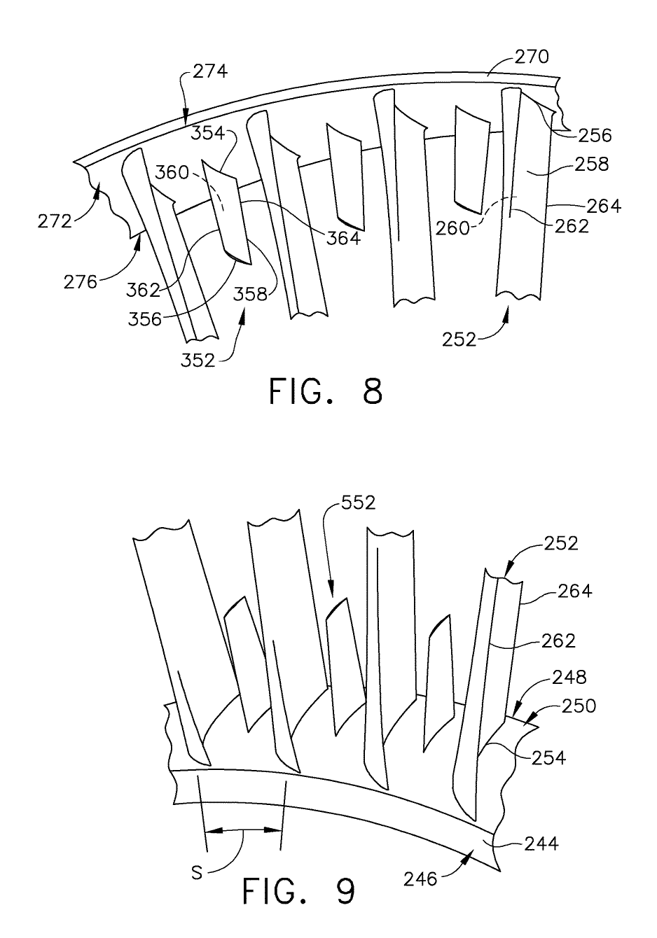

FIGS. 8-11 illustrate a portion of an exemplary stator structure that is suitable for inclusion in the HPC 16. As an example, the stator structure may be incorporated into one or more of the stages in the aft half of the HPC 16, particularly the last or aft-most stages. The stator structure includes several rows of airflow-shaped compressor stator vanes 252. These are bounded by an inner band 244 and a casing 270, respectively. For the purposes of this document, the compressor stator vanes 252 may all be referred to as “stator airfoils”.

The inner band 244 defines an annular inner flowpath surface 250 extending between forward and aft ends 246, 248. The casing 270 defines an annular outer flowpath surface 272 extending between forward and aft ends 274, 276.

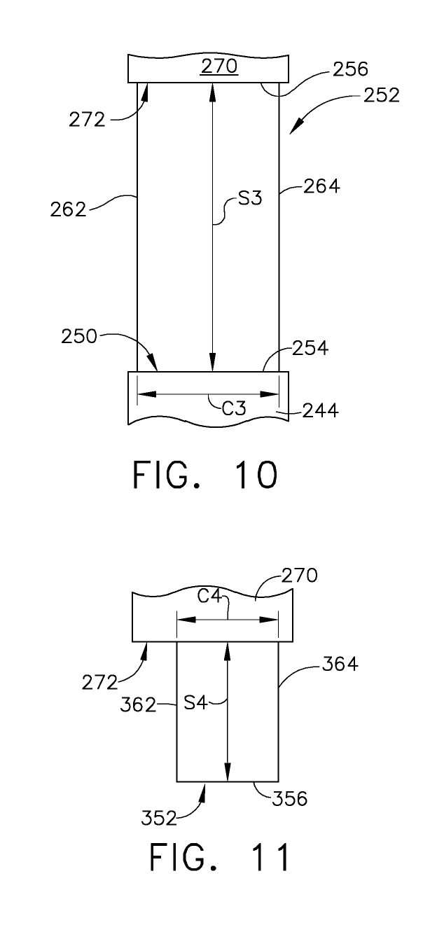

The stator vanes 252 extend between the inner and outer flowpath surfaces 250, 272. Each stator vane 252 extends from a root 254 at the inner flowpath surface 250 to a tip 256 at the outer flowpath surface 272, and includes a concave pressure side 258 joined to a convex suction side 260 at a leading edge 262 and a trailing edge 264. As best seen in FIG. 10, each stator vane 252 has a span (or span dimension) “S3” defined as the radial distance from the root 254 to the tip 256, and a chord (or chord dimension) “C3” defined as the length of an imaginary straight line connecting the leading edge 262 and the trailing edge 264. Depending on the specific design of the stator vane 252, its chord C3 may be different at different locations along the span S3. For purposes of the present invention, the relevant measurement would be the chord C3 at the root 254 or tip 256. The stator vanes 285 are uniformly spaced apart around the periphery of the inner flowpath surface 250. The stator vanes 252 have a mean circumferential spacing “s”, defined as described above (see FIG. 9). A nondimensional parameter called “solidity” is defined as c/s, where “c” is equal to the vane chord as described above. In the illustrated example, the stator vanes 252 may have a spacing which is significantly greater than a spacing that would be expected in the prior art, resulting in a vane solidity significantly less than would be expected in the prior art.

As seen in FIGS. 8 and 9, the inner and outer flowpath surfaces 250, 272 are depicted as bodies of revolution (i.e. axisymmetric structures). Optionally, either or both of the inner or outer flowpath surfaces 250, 272 may have a non-axisymmetric surface profile (not shown).

In operation, there is a potential for undesirable flow separation on the suction side 260 of the stator vane 252, at the inboard portion near the root 254, and at an aft location, also referred to as “hub flow separation”. It also tends to cause undesirable flow separation on the suction side 260 of the stator vane 252, at the outboard portion near the tip 256, and at an aft location, also referred to as “case flow separation”. Generally, both of these conditions may be referred to as “endwall separation”.

To counter this adverse side effect, one or both of the inner and outer flowpath surfaces 250, 272 may be provided with an array of splitter vanes. In the example shown in FIG. 8, an array of splitter vanes 352 extend radially inward from the outer flowpath surface 272. One splitter vane 352 is disposed between each pair of stator vanes 252. In the circumferential direction, the splitter vanes 352 may be located halfway or circumferentially biased between two adjacent stator vanes 252. Stated another way, the stator vanes 252 and splitter vanes 352 alternate around the periphery of the outer flowpath surface 272. Each splitter vane 352 extends from a root 354 at the outer flowpath surface 272 to a tip 356, and includes a concave pressure side 358 joined to a convex suction side 360 at a leading edge 362 and a trailing edge 364. As best seen in FIG. 11, each splitter vane 352 has a span (or span dimension) “S4” defined as the radial distance from the root 354 to the tip 356, and a chord (or chord dimension) “C4” defined as the length of an imaginary straight line connecting the leading edge 362 and the trailing edge 364. Depending on the specific design of the splitter vane 352, its chord C4 may be different at different locations along the span S4. For purposes of the present invention, the relevant measurement is the chord C4 at the root 354.

The splitter vanes 352 function to locally increase the hub solidity of the stator and thereby prevent the above-mentioned flow separation from the stator vanes 252. A similar effect could be obtained by simply increasing the number of stator vanes 252, and therefore reducing the vane-to-vane spacing. An undesirable side effect of increased solidity is reduced choking relief during low op-line operation and higher inefficiency. Therefore, the dimensions of the splitter vanes 352 and their position may be selected to prevent flow separation while minimizing their surface area. The splitter vanes 352 are positioned so that their trailing edges 364 are at approximately the same axial position as the trailing edges 264 of the stator vanes 252, relative to the outer flowpath surface 272. This can be seen in FIG. 8. The span S4 and/or the chord C4 of the splitter vanes 352 may be some fraction less than unity of the corresponding span S3 and chord C3 of the stator vanes 252. These may be referred to as “part-span” and/or “part-chord” splitter vanes. For example, the span S4 may be equal to or less than the span S4. Preferably for reducing frictional losses, the span S4 is 50% or less of the span S3. More preferably for the least frictional losses, the span S4 is 30% or less of the span S3. As another example, the chord C4 may be equal to or less than the chord C3. Preferably for the least frictional losses, the chord C4 is 80% or less of the chord C3.

FIG. 9 illustrates an array of splitter vanes 552 extending radially outward from the inner flowpath surface 250. One splitter vane 552 is disposed between each pair of stator vanes 552. Other than the fact that they extend from the inner flowpath surface 250, the splitter vanes 552 may be identical to the splitter vanes 552 described above, in terms of their shape, circumferential position relative to the stator vanes 252, and their span and chord dimensions. As noted above, splitter vanes may optionally be incorporated at the inner flowpath surface 250, or the outer flowpath surface 272, or both.

The variable-cycle engine having the compressor apparatus described herein with splitter airfoils (splitter blades and/or splitter vanes) has several advantages over the prior art. It increases the endwall solidity level locally, reduces the endwall aerodynamic loading level locally, and suppresses the tendency of the airfoil portion adjacent the endwall to want to separate.

The part span splittered rotor concept described above reduces overall rotor solidity levels while simultaneously managing the tendency of the rotor airfoil hub to want to separate, due to the reduced solidity, and provides variable cycle benefit through a compressor efficiency increase during low operating line operation.

The use of a splittered compressor enables higher overall pressure ratio thermodynamic cycles that will yield reduced engine fuel burn levels. It improves variable-cycle turbine engine performance and enables more efficient operation over wider ranges and flight regimes. The concept is and un-intrusive to implement.

The foregoing has described a gas turbine engine with a splittered compressor. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

What is claimed is:

1. A variable-cycle compressor apparatus, comprising:
an axial-flow compressor that discharges into a downstream flowpath;
at least one variable-cycle device operable to vary a choked flow capacity of the downstream flowpath;
wherein the compressor includes:
a rotor comprising at least one rotor stage including a rotatable disk defining a rotor flowpath surface and an array of axial-flow rotor airfoils extending outward from the flowpath surface;
at least one stator stage comprising a wall defining a stator flowpath surface, and an array of axial-flow stator airfoils extending away from the stator flowpath surface; and
wherein at least one of the rotor or stator stages includes an array of airfoil-shaped splitter airfoils extending from at least one of the flowpath surfaces thereof, the splitter airfoils alternating with the rotor or stator airfoils of the corresponding stage, wherein at least one of a chord dimension of the splitter airfoils and a span dimension of the splitter airfoils is less than the corresponding dimension of the airfoils of the at least one stage.

2. The apparatus of claim 1 wherein the downstream flowpath includes:
a combustor; and
a turbine mechanically coupled to the compressor.

3. The apparatus of claim 1 wherein at least one of the flowpath surfaces is not a body of revolution.

4. The apparatus of claim 1 wherein each splitter airfoil is located approximately midway between two adjacent rotor or stator airfoils.

5. The apparatus of claim 1 wherein the splitter airfoils are positioned such that their trailing edges are at approximately the same axial position as the trailing edges of the rotor or stator airfoils, relative to the corresponding flowpath surface.

6. The apparatus of claim 1 wherein the span dimension of the splitter airfoils is 50% or less of the span dimension of the corresponding rotor or stator airfoils.

7. The apparatus of claim 1 wherein the span dimension of the splitter airfoils is 30% or less of the span dimension of the corresponding rotor or stator airfoils.

8. The apparatus of claim 6 wherein the chord dimension of the splitter airfoils at the roots thereof is 80% or less of the chord dimension of the corresponding rotor or stator airfoils at the roots thereof.

9. The apparatus of claim 1 wherein the chord dimension of the splitter blades at the roots thereof is 80% or less of the chord dimension of the corresponding rotor or stator airfoils at the roots thereof.

10. The apparatus of claim 1 wherein the compressor includes multiple stator and rotor stages, and the splitter airfoils are incorporated into one or more of the stages located in an aft half of the compressor.

11. The apparatus of claim 1 wherein the at least one stage is the aft-most rotor or stator stage of the compressor.

12. A method of operating an axial-flow compressor, comprising:
driving the compressor so as to generate a fluid flow which is discharged into a downstream flowpath, wherein the compressor includes at least one row of splitter airfoils; and
during compressor operation, using at least one variable-cycle device to vary a choked flow capacity of the downstream flowpath, thereby moving an operating line of the compressor by at least 5% from a nominal position.

13. The method of claim 12 wherein the downstream flowpath includes:
a combustor; and
a turbine mechanically coupled to the compressor.

14. The method of claim 12 wherein the variable-cycle device is used to lower the compressor operating line relative to the nominal position.

15. The method of claim 12 wherein the compressor comprises:
a rotor comprising at least one rotor stage including a rotatable disk defining a rotor flowpath surface and an array of axial-flow rotor airfoils extending outward from the flowpath surface;
at least one stator stage comprising a wall defining a stator flowpath surface, and an array of axial-flow stator airfoils extending away from the stator flowpath surface; and
wherein at least one of the rotor or stator stages includes an array of airfoil-shaped splitter airfoils extending from at least one of the flowpath surfaces thereof, the splitter airfoils alternating with the rotor or stator airfoils of the corresponding stage, wherein at least one of a chord dimension of the splitter airfoils and a span dimension of the splitter airfoils is less than the corresponding dimension of the airfoils of the at least one stage.

16. The method of claim 15 wherein each splitter airfoil is located approximately midway between two adjacent rotor or stator airfoils.

17. The method of claim 15 wherein the splitter airfoils are positioned such that their trailing edges are at approximately the same axial position as the trailing edges of the rotor or stator airfoils, relative to the corresponding flowpath surface.

18. The method of claim 15 wherein the span dimension of the splitter airfoils is 50% or less of the span dimension of the corresponding rotor or stator airfoils.

19. The method of claim 15 wherein the span dimension of the splitter airfoils is 30% or less of the span dimension of the corresponding rotor or stator airfoils.

20. The method of claim 19 wherein the chord dimension of the splitter airfoils at the roots thereof is 80% or less of the chord dimension of the corresponding rotor or stator airfoils at the roots thereof.

21. The method of claim 15 wherein the chord dimension of the splitter airfoils at the roots thereof is 80% or less of the chord dimension of the corresponding rotor or stator airfoils at the roots thereof.

22. The method of claim 12 wherein the compressor includes multiple stator and rotor stages, and the splitter airfoils are incorporated into one or more of the stages located in an aft half of the compressor.
